(19) United States
(12) Patent Application Publication
(10) Pub. No.: US 2021/0342254 A1
(43) Pub. Date: Nov. 4, 2021

(54) Automated electronics to difficult sail lowering in quickly changing wind spee

(71) Applicant: Joel Arthur Epstein, Las Vegas, NV (US)

(72) Inventor: Joel Arthur Epstein, Las Vegas, NV (US)

(21) Appl. No.: 17/300,276

(22) Filed: May 11, 2021

Related U.S. Application Data
(63) Continuation-in-part of application No. 16/501,929, filed on Jul. 8, 2019.

(51) Int. Cl. G06F 11/36; G06F 11/34

(52) U.S. Cl. CPC G06F 11/3664; G06F 11/3636; G06F 11/3433; G06F 11/3624

(57) ABSTRACT

In this continuation in part, the characteristics of the reverse debugger and its ability to expedite the debugging of the 32-bit microcontroller are set forth; the algorithms and computer coding which make it work, and why its importance is critical to the implementation of safe operational maintenance of the 32 bit microcontroller aboard the sailboat at sea. This advanced debugger allows the user to perform all the usual operations for stepping code-in reverse. This time saving technology allows users to quickly hone in on errors in one debugging session. Interactive reverse debugging is often coupled with remote reverse debugging. In one iteration of remote debugging, reverse debugging is deployed on a different computer out to sea in a remote location. Thus the reverse debugger is available virtually in any location.

### BACKGROUND OF THE INVENTION

To control a sailing boat, its sails need to be moved or otherwise adjusted using the vessel's rope lines, collectively called the naming rigging. Furthermore, autonomous jib sheets are used to adjust the effective angle of the jib sail. A variety of other lines are often-used to control after aspects of the position and dope of sail(s).

In most sailing boats, lines are manually controlled, although autonomous and semi-autonomous sailing boats are known. For example, some yachts have electric or hydraulic winches to wind in or let out lines that can be controlled at a user interface (e.g. by buttons)

The sport of sailing is enjoyed by many and at least part of the enjoyment is generally derived from manually participating in controlling the vessel. Technology is such that sailing vessels can control themselves autonomously bat such systems would detract from fee sailing experience in a recreational setting.

One well known problem in sailing is when vessels heel at too great an angle. This can happen due to a gust of wind or simply due to user error. If a vessel heels at too great an angle, it may capsize and this can cause damage to the vessels or its contents. There are several known solutions to vessels over-heeling and these include: accommodative hull design, a weighted keel and movement of the crew to the high side of the vessel.

The present invention seeks to provide a sailing vessel control device and system which will overcame, or substantially ameliorate, at least some of the deficiencies of the prior art, or at least provide an alternative.

It is to be understood that, if any prior art information is referred to herein, such reference does not constitute an admission that the information forms part of the common general knowledge in the art, in the United States or any other country.

Preferably, the actuator and sensor are provided by a servo motor.

Advantageously, by using a servo motor, the position of the line can be detected and a feedback force can be applied to the line by a single unit.

Preferably, the resistance means is a biasing means adapted to bias the line towards the biasing means.

Advantageously, this emulates more closely the feeling of pulling on a sail line (e.g. a main sheet or a jib sheet).

Preferably, the biasing means is a gas spring. In another embodiment, the biasing means is a coil spring.

Preferably, the sailing vessel control device further comprises a pulley arrangement and wherein an intermediate portion of the line is threaded through the pulley arrangement to provide a mechanical advantage to a user pulling on the first end of the line in use.

According to a second aspect of the present invention, a sailing vessel control system is provided comprising: one or more of the sailing vessel control devices according to the invention, one or more sail actuators, and a control unit adapted to receive and then process the one or more line signals and to send one or more actuator signals to the respective one or more sail actuators to cause the one or more sail actuators to move one or more corresponding sails.

Advantageously, the system allows a sailing vessel to be controlled electronically but in conjunction with a traditional user interface (i.e. one or more lines).

Advantageously, the force required to trim the sail is independent of the sail size. This allows users who are physically less strong (e.g. the elderly) to trim any sail size. Furthermore, the crew does not have to handle lines under high loads directly. This eliminates associated hazard (e.g. muscle strain).

Advantageously, the mounting position of the one or more sail actuators (e.g. winches) is more flexible. No physical access is required during normal operation since the actuators) are controlled electronically. The flexible actuators) position can be used to remove line clutter in the cockpit. Furthermore, in another embodiment, linear actuators could be installed within or on (i.e. the outside of) the mast or boom.

Preferably, the sailing vessel control system further comprises one or more vessel sensors and wherein the control unit is further adapted to receive and process information from the one or more actuator signals to improve sailing effectiveness, in use.

Advantageously, it is possible to automate sail trim or improve or optimize the trim of a sail that has only been trimmed manually. The control unit can send trim commands to the one or more sail actuators based on environmental or other variables detected by the one or more vessel sensors.

Advantageously, safety functions can be incorporated. For example, if one of the environmental variables or heel angle exceeds a certain limit then the sail(s) can be automatically eased or power to the winch can be cut.

Preferably, the one or more vessel sensors from the following group of sensors: a wind speed sensor, a wind direction sensor, a heel sensor, a servo input, a rudder position sensor, a user input device and a GPS unit.

Preferably, the one or more actuators are adapted to apply a feedback force to the line that is substantially proportional to the resistance experienced by one or more sail actuators in use.

Advantageously, the sailor is provided with an accurate feeling of the load on a given sail(s).

Preferably, the one or more vessel sensors comprise at least a wind direction sensor and a heel sensor and die control unit is adapted to identify the tack of the vessel in use, based CHI the information received from these sensors and to send one or more actuator signals to at least one of the one or more sail actuators to move a jib sail based on the tack of the vessel in use.

Advantageously, the vessel is able to tack its jib sail autonomously. This can allow or make it easier for a single sailor to sail a large yacht. In one embodiment, this functionality is activated automatically as required when a sailor fails to tack a vessel appropriately.

Preferably, the one or more vessel sensors further comprise a rudder position sensor.

According to a third aspect of the present invention, a sailing vessel control system is provided, comprising: one or more sail actuators adapted for moving one or more sails of a vessel, a processor adapted to control the one or more sail actuators, and one or more vessel heel sensors adapted to send heel signals to the processor, the processor being further adapted to receive and process the heel signals and to send one or more actuator signals to the one or more sail actuators to cause the sail actuators to ease one or more sails if the heel angle of the vessel is excessive.

Advantageously, the system may allow a capsize scenario or excessive heel resulting in reduced sailing efficiency to be avoided.

Other aspects of the invention are also disclosed.

### PATENT CITATIONS

TABLE-US-00001 [0029] Publication No. Priority date Publication date Assignee U.S. Pat. No. 4,022,144A 1976 Apr. 15 1977 May 10 Gitchel U.S. Pat. No. 4,671,201A 1985 Jun. 26 1987 Jun. 9 Jimusho U.S. Pat. No. 4,886,007A 1988 Jul. 27 1989 Dec. 12 Robert FR2682661A1 1991 Oct. 17 1993 Apr. 23 Proegin U.S. Pat. No. 5,211,378A 1991 Jun. 10 1993 Dec. 21 Kaisha US546772A 1994 Dec. 16 1995 Nov. 21 Hutchins EP0823372A2 1996 Aug. 7 1998 Feb. 11 Magazzu WO1998024687A1 1996 Dec. 5 1998 Jun. 11 Aeromax U.S. Pat. No. 6,050,209A 1997 Apr. 23 2000 Apr. 18 Vincent U.S. Pat. No. 6,308,649B1 1999 Jan. 12 2001 Oct. 30 Gedeon U.S. Pat. No. 6,718,898B1 2002 Sep. 23 2004 Apr. 13 Anderson FR2864517A1 2003 Dec. 24 2003 Jul. 1 Ganovelli U.S. Pat. No. 8,726,824B2 2010 Mar. 23 2014 May 20 Jarke

### SUMMARY OF THE INVENTION

According to a first aspect of the present invention, a sailing vessel control device is provided, comprising: a cleat means, a resistance means, a line having a first end located through the cleat means, and a second end attached to the resistance means, and a sensor adapted to detect the extent to which the line is pulled through the cleat means and to output a line signal corresponding to the position of the line for use in controlling the sailing vessel.

Advantageously, a control signal (i.e. the line signal) which can be used to control the sail(s) of the vessel can be generated in a traditional, manual manner (i.e. by pulling on the line). This allows emulation of traditional sailing rigging to control a sailing vessel electronically and thus technological innovation can be incorporated into the sailing experience without detracting from the sailor's enjoyment.

Advantageously, the line signal may serve as an input into an algorithm executed by a processor, Tricore (harsh environments) or equal, which can then generate an output signal to control an electric winch or other actuator to change the sail angle, position or shape. The algorithm may additionally receive other inputs (e.g. from sensors) to augment or modify the output signal for the purposes of improving sailing effectiveness or safety, for example.

Preferably, the sailing vessel control device further comprises an actuator adapted to apply a feedback force to the line.

Advantageously applying a feedback force to the line enhances the user's sailing experience by emulating traditional sailing to an even greater extent. If the feedback force is representative of the load on the sail(s) then this can assist the user in adjusting the sail(s) to obtain a desired sailing outcome.

### DETAILED DESCRIPTION OF SPECIFIC EMBODIMENTS

It should be noted in the following description that like or the same reference numerals in different embodiments denote the same or similar features.

Referring to FIG. 1, it should be understood that although a model of a vessel incorporating a sailing vessel control system is shown, this is merely to illustrate the functionality of the proposed sailing vessel control device, and system, and in a real-life, full-size embodiment, all components would be adjusted/replaced by equivalent or similar components as required.

For the purposes of this description, the vessel model will be described as though they were those of a full-sized sailing vessel. Thus, the sailing vessel 10 comprises a hull 11, a sail 12 and a sailing vessel control system 13 which, in turn, comprises a single sailing vessel control device 13.

The sailing vessel control device IS comprises a cleat means taking the form of a standard cleat 20, a resistance means taking the form of a gas spring 25. The gas spring 25 comprises a piston member (not shown), a piston extension 26 and a cylinder 27. The sailing vessel control device 15 further comprises a line 30 having a first end 35 located through the cleat 20 and a second end 40 attached to the piston extension 26 and being adapted to both: (i) detect the extent to which the line 30 is pulled through the cleat 20 and to output a line signal corresponding to the position of the line 30, and (ii) to apply a feedback force to the line.

The sailing vessel control device IS further comprises a pulley arrangement 55, wherein an intermediate portion of the line 30 is threaded through the pulley arrangement 55 to provide a mechanical advantage to a user pulling on the first end of the line 30 in use.

An optical encoder 56 interconnects and allows signals to be sent between the control unit 75 and the sail actuator 60.

The sailing vessel control device 15 provides at least the following advantages:

1. The line signal which is outputted by the servo motor 45 can be used to control the sail 12 of the vessel 10 and is generated in a traditional manual manner (i.e. by pulling on the line 30), This allows emulation of traditional sailing rigging to control the vessel 10 electronically, and thus technological innovation can be incorporated into the sailing experience without detracting from the sailor's enjoyment 2. The line signal may serve as an input into an algorithm executed by a processor, Tricore (for harsh environments) or other similar processor, which can then generate an output signal to control an electric winch or other actuator to change the sail angle, position or shape. The algorithm may additionally receive other inputs (e.g. from sensors) to augment or modify the output signal for the purposes of improving sailing effectiveness or safety, for example. 3. Applying a feedback force to line 30 enhances the user's sailing experience by emulating traditional sailing to a greater extent. In this embodiment, the feedback force is representative of the load on the sail 12 and this can assist the user in adjusting the sails(s) to obtain a desired sailing outcome. 4. The servo motor 45 allows the position of the line 30 to be detected and a feedback force to be applied to the line 30 by a single unit.

It should be noted that in a simpler embodiment, the servo motor 45 is replaced by a string potentiometer and no feedback force is provided.

The sailing vessel control system 13 also comprises a sail actuator 60, a wind vane 65, a heel sensor 70, a control unit 75 and a user interface 80. The control unit 75 is adapted to receive, and then process the line signals and the data outputs from the wind vane 65, heel sensor 70 and user interface 80, and to create and send actuator signals to the sail actuator 60 to cause it to move the main sail 12. In one embodiment, the actuator signals may be modified by the control unit 75 based on the data output from the wind vane 65 (which measures wind speed and direction) and the heel sensor 70 to improve sailing effectiveness.

In another embodiment, a variety of other vessel sensors may be incorporated into/onto the vessel 10 and connected to the control unit 75. These vessel sensors may include a rudder position sensor and/or a GPS unit.

In this embodiment, the servo motor 45 is adapted to apply a feedback force to the line 30 (via the control rod arrangement 50) that is substantially proportional to the resistance experienced by the sail actuator 60 in use (i.e. the force of the wind against the sail 12). The sailing vessel control system 13 provides at least the following advantages: 1. It allows the sailing vessel 10 to be controlled electronically, but in conjunction with a traditional user interface (i.e. (me or more lines 30). 2. The force required to trim the sail 12 is independent of the size of the sail 12. This allows users who are physically less strong (e.g. the elderly) to trim any sail size. Furthermore, the crew does not have to handle lines 30 under high loads directly. This eliminates associated hazards (e.g. muscle strain). 3. The mounting position of the sail actuator 60 (e.g. a winch) is more flexible. No physical access is required during normal operation since the actuator 60 is controlled electronically. The flexible actuator position ram be used to remove line clutter in the cockpit. Furthermore, in another embodiment, linear actuators could be installed in or on the mast or boom. 4. It is possible to automate the trim of the sail 12 or improve the trim of the sail 12 if it has only been manually trimmed. The control unit 73 can send trim commands to the sail actuator 60 based on environmental or other variables detected by the vessel sensors (e.g. the wind vane 65 & heel sensor 70). 3. Safety functions can be incorporated. For example, if one of the environmental variables or heel angle exceeds a certain limit, then the sail 12 can be automatically eased, or power to the actuator (a winch) can be cut. 6. The sailor can be provided with an accurate feeling of the load on a given sail by virtue of the feedback through the line 30.

In another embodiment, a vessel 10A, further comprises a jib sail, a rudder position sensor, a jib sailing vessel control device ISA, a jib actuator 60A and a control unit 75A. The control unit 75A is adapted to identify the tack of the vessel 10A in use, based on the information received from the rudder position sensor, the wind vane 65A, and the heel sensor 70A to send actuator signals to the jib actuator 60A to move the jib sail based on the tack of the vessel 10A in use.

Advantageously, the vessel 10A is able to tack its jib sail autonomously. This can allow or make it easier for a single sailor to sail a large yacht. In one embodiment, this functionality is activated automatically, as required when a sailor fails to tack the vessel 10A appropriately.

In yet another embodiment, a sailing vessel control system 13B comprises a vessel heel sensor 70B adapted to send heel signals to a processor, the processor being further adapted to receive and process the heel signals and to send actuator signals to a sail actuator 60B, to ease a sail 12B if the heel angle of a vessel is excessive.

Thus if a programmed heel angle is exceeded, the sail actuator 60C automatically eases the main sail 12B to prevent loss of control over the vessel direction. Once the heel angle has recovered, the previous operating mode is entered.

Advantageously, the system 13B may allow a capsize scenario or excessive heel, resulting in reduced sailing efficiency to be avoided. This safety feature is very useful for modern wide beam boats which become uncontrollable at relatively small heel angles, or catamarans where preventing capsizing is particularly important.

Referring to FIG. 2, a sailing vessel control system 13C, comprises a sail actuator 60C, a control unit 75C, a servo motor 45C, a user interface 80C, a wind vane 65C, and a GPS antenna 100C. Specifically, the control unit 75C comprise an electric amplifier 105C, as in this embodiment the sail actuator 60C is electrically powered, a motion controller 115C, and a central controller 120C. In another embodiment, the sail actuator 60C is hydraulically powered, and thus the control unit 75C comprises one or more hydraulic control valves instead of the electric amplifier 105C.

The motion controller, 115C, reads the position and force feedback (shown in FIG. 2 by line 121 C) from die sail actuator 60C, and sends this data to the central controller 120C. It also receives position or speed commands from the central controller 120C. The motion controller, 115C, also sends control commands to the electric amplifier 105 via an analog connection, 122C, or alternatively, a PWM (Pulse Width Modulation) connection to reduce the position error or to achieve a desired sail actuator 60C speed.

The central controller 120C sends position or speed commands to the motion controller, 115C. It also receives data inputs from the wind vane 65C (i.e. wind speed and direction sensor), a heel sensor 70C, the servo motor 45C, a rudder position sensor, and a joystick. The central controller 120C receives force data from the motion controller, 115C. If force feedback is enabled, the central controller, 120C, sends force commands to the servo motor 45C. The central controller 120C further comprises computer readable memory, in which a database of available sails, including the following information is stored: 1. sail identification 2. maximum and minimum actuator positions 3. maximum sheet load 4. fine trim parameters 5. force feedback parameters

In this case, the servo motor 45C, is connected to a spring-loaded control line manually operated by the crew. The central controller, 120C, is adapted to measure the position (length) of the spring.

In another embodiment, the spring is replaced by a variable force actuator. The force actuator receives force commands from the central controller, 120C and the central controller, 120C, measures the position (length) of the force actuator.

The sailing vessel control system 13C can be operated in a number of different modes, including:

Manual Mode:

In this mode, the speed of the movement of the sail actuator, 60C, is controlled by a joystick. That is, the central controller, 120C sends speed commands to the motion controller, 115C, based on the joystick input. Other input devices may be used instead of the joystick, such as a mouse or keyboard.

In this mode, the central controller, 120C, sends position data to the motion controller, 115C, based on the position of the servo motor 45C. The relationship between the position of the servo motor, 45C and the position of the sail actuator, 60C can be linear or non-linear. A non-linear relationship allows implementation of electronic fine trim.

An example of electronic fine trim follows:

When sailing downwind, a small position change from the servo motor, 45C, leads to a large change of the winch position. When sailing upwind, this is reversed, and a large position change from the servo motor, 45C, is required to trim the sail 12C. This allows for finer adjustments when sailing upwind.

It should be noted that in one embodiment, the servo mode is entered by moving the servo motor 45C, to the current sail actuator, 60C position.

Servo Mode with Force Feedback

In this mode, the central controller 120C sends position data to the motion controller 115C based on the position of the servo motor 45C. The relationship between the position of the servo motor 45C and the position of the sail actuator 60C can be linear and non-linear. The central controller 120C sends force commands to the servo motor 45C based on force data received from motion controller 115C. The relationship between the force on the sheet and the force applied to the control line 30C can be linear or non-linear.

Automatic Mode

In this mode, the central controller, 120C, sends position commands to the motion controller, 115C, based on the wind direction and speed. The control unit, 75C, trims the sail automatically, without user input, based on trim curves preprogrammed into the central controller 120C. In one embodiment, different trim curves are provided for different wind strengths to account for stretch in the sails and sheets, and different optimum sail trim angles.

Automatic Tack Function

In this mode, the jib sail is self-tacking. The control, 75C, senses tack based on rudder angle, change of heel angle and change of wind direction. The controller unit, 75C, also eases the jib sheet on the old tack and pulls the jib sheet on to the new tack. Only one servo device, 45C, would be required to control either of the jib winches, as the control unit, 75C may be adapted to automatically activate the correct winch.

Heel Angle Monitoring:

In this mode, the control unit, 75C, monitors the heel angle. If the heel angle exceeds a certain programmed value, the main sheet is eased automatically. The main sheet is then trimmed back to its previous position, if the heel angle recovers.

Sheet Overload Protection:

The control unit, 75C, releases the sheet, if the sheet load exceeds a certain maximum sheet load for the sail 12C stored in the database.

In this embodiment, a dedicated serial data connection 130C is provided and interconnects the central controller, 120C, and the motion controller, 115C. The central controller, 120C, can be also connected to a NMEA 2000 network, 140C, or other equivalent, or similar network to receive sensor data.

In one embodiment, by also connecting the winch controller to the NMEA 2000 network 140C, a second communication link between the winch controller and central controller can be created. This additional communication link can be used in fault situations as a back-up. Reduced functionality would be available even if the NMEA 2000, 140C, of the dedicated serial connection, 130C, is down, and the user interface 80C has a fault.

Furthermore, by virtue of the NMEA2000 network, 140C, it is possible for the user interface, 80C, to display functions other than the sail-by-wire functions discussed above. A fully integrated system allows operation of the sail actuators, 60C, navigation lights, auto-pilots, engine and generator, and could further display GPS information, wind information, tank and battery levels, engine temperature, engine RPM, boat speed and heel angle. The user interface 80C could also receive data from a navigation unit and display a moving map image. An example of such a user interface, 80C, is shown in FIG. 3.

While the invention has been described with reference to a number of preferred embodiments, it should be appreciated that the invention can be embodied in other forms.

For example, the sail actuator of any of the above embodiments, may take the form of, inter alia, a winch or a linear actuator. The winch can be electrically or hydraulically powered, and the linear actuator can be hydraulically or electrically powered. By use of a transducer, the actuator can provide position feedback to the control unit, and the and the actuator can also provide force feedback to the line.

In one embodiment where the motion controller is a winch controller, the winch controller may monitor the actual position of the winch by analyzing signals from the position transducer mounted to signal the winch. The winch controller receives position commands from the central controller, compares the command position to die actual position, and supplies power to the winch motor to reduce the position error. For smooth winch movement, acceleration and speed curves, or maximum accelerations and speeds, can be programmed. The winch controller also sends status data to the central controller.

In another embodiment, the central controller also monitors the status of various sensors and buttons and communicates with a user interface. The central controller may also be adapted to detect fault situations based on sensor input, and/or feedback data.

In yet another embodiment, the user interface displays various vessel information and allows a user to operate the sail actuator (e.g. winch) via buttons, and brings about important parameters (e.g. sail parameters) to be changed.

In another embodiment, the load on the sail actuator is continuously monitored. On electric winches, the current consumed by the winch motor is substantially proportional to the load on the winch. The sailing vessel control system can be configured such that once the load exceeds a programmable limit, the winch automatically cuts power to the motor and eases the sheet. The winch is re-started via user input.

In yet another embodiment, the user interface includes a panic button, which when pressed, immediately stops the sail actuators).

In another embodiment, the actuator of the sailing vessel control device is also the resistance means. For example, where the actuator is a servo motor, the servo motor may be adapted to provide a tension force in the line, and thus no separate resistance means is required.

In describing the preferred embodiment of the invention illustrated in the drawings, specific terminology will be resorted to fix the sake of clarity. However, the invention is not intended to be limited to the specific terms so selected, and it is to be understood that each specific term includes all technical equivalents which operate in a similar manner to accomplish a similar technical purpose.

It is apparent from the above that the arrangements described are applicable to the manufacture of sailing vessels, amongst other industries.

In the which follow and in the preceding description of the invention, except where the context requires, otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

### BRIEF DESCRIPTION OF THE DRAWINGS

Notwithstanding any other forms which may fall within the scope of the present invention, preferred embodiments of the invention will now be described, by way of example only, with reference to the accompanying drawings in which:

FIG. 1 is a perspective view of a model of a vessel incorporating a sailing vessel control system in accordance with a preferred embodiment of the present invention where the vessel sail is shown in phantom lines;

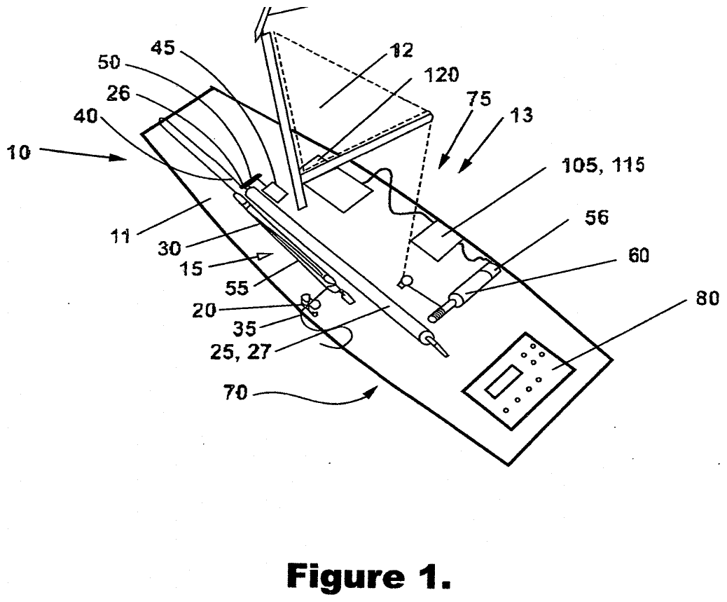

FIG. 2 is a diagram of a sailing vessel control system in accordance with another preferred embodiment of the present invention; and

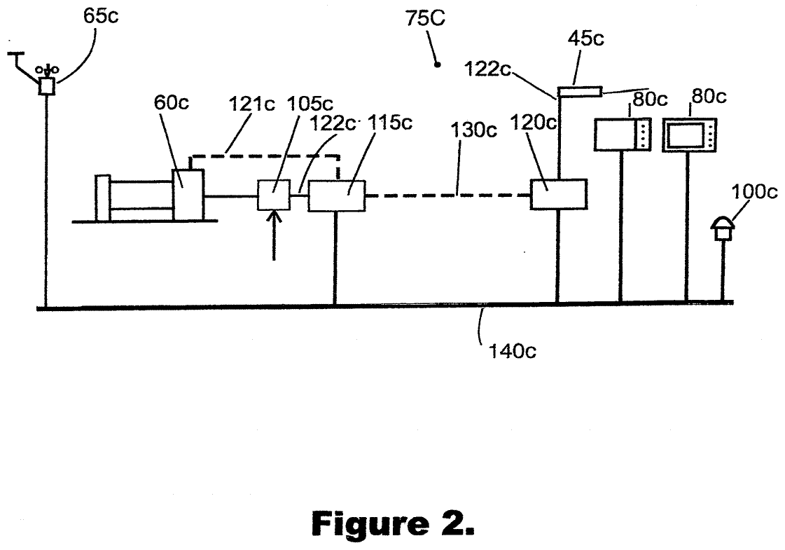

FIG. 3 is a schematic diagram of a user interface of the sailing vessel control system of FIG. 2.

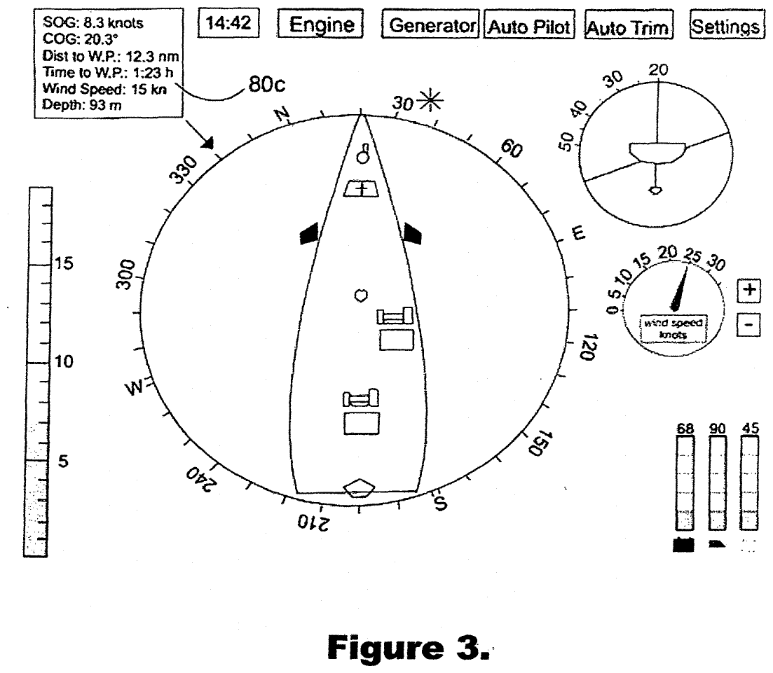

FIG. 4 is a schematic diagram of a 32 bit microcontroller block chain.

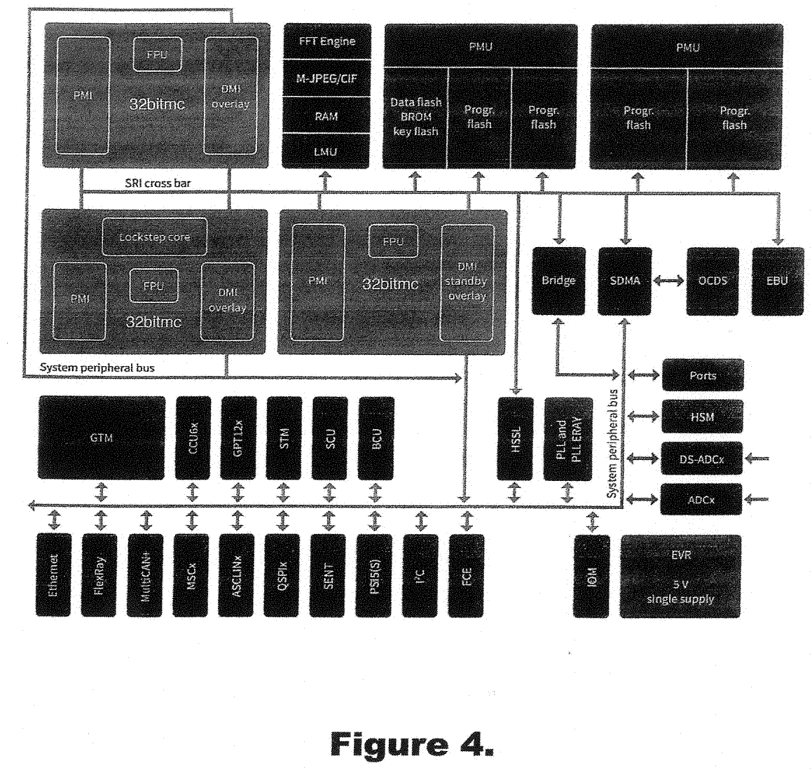

1. I claim the use of parallel algorithms, which run on a 32-bit microcontroller (32 bitmc contraction will be used to denote the 32-bit microcontroller throughout this continuation in part), that permits multiple instructions to execute concurrently. In particular, dynamic multithreaded algorithms are amenable to algorithmic design and analysis; efficient and dynamic implementation in practice make the debugger/32-bit microcontroller possible. Dynamic multithreading allows parallelism in 32 bitmc's without worrying about communication protocols, load balancing, and other vagaries of static-thread programming The concurrency platform contains a scheduler, which load-balances the computation automatically, thereby providing simplification of programming. Dynamic-multithreading environments are still evolving; almost all support: nested parallelism and parallel loops. Nested parallelism allows a subroutine to be “spawned”, allowing the caller to proceed while the spawned subroutine is computing its result. A parallel loop is like an ordinary for loop, except that the iterations of the loop can execute concurrently.

2. In this embodiment, according to claim 1, utilizing parallel algorithms, a reverse debugger specifically developed for use on sailing vessels to be used with the 32 bitmc, that starts a process to eliminate bugs, so that the 32 bitmc operates nominally when the aforementioned reverse debugger is plugged into the USB port of the 32 bitmc aboard the sailboat, and debugs it utilizing reverse debugger technology. Reverse debugging works as follows: Instead of seeing the code as it currently is, going back in time is the methodology employed. Through the lens of a reverse debugger tool, every line of code can be seen—including variables and return values of executed methods—to understand why those particular code paths were executed. With reverse bugging, there's no need to spend great amounts of time looking for unhandled exceptions. All is traced through the debugger tool. The process allows backward movement, starting from the moment the anomaly or bug were thrown or captured, to the real cause as why it happened. Once this is known, solving the problem becomes far easier.

3. according to claim 2, preferably, implementation of coding will be on Linux or C, C++, or other like systems—the ptrace system call. All the code mentioned in this or further claims is developed on a 32 bit Ubunto machine. The code is very much platform specific, although porting it to other platforms is not difficult.

4. according to claim 3 implementation of coding, advantageously, the reverse debugger can also single-step through the code, set breakpoints and run to them, examine variable values and stack traces. Many debuggers have advanced features such as executing expressions and calling functions in the debugged process's address space, and even changing the process's code on-the-fly and watching the effects. Although modern debuggers are complex, the foundation on which they are built is simple. Debuggers do start with a few basic services provided by the operating system and the compiler/linker, all the rest is just a simple matter of programming. The versatility of the Linux debuggers is characterized in the ptrace system call. It's a versatile and complex tool that allows one process to control the execution of another and to peek and poke at its innards, ptrace takes a mid-sized book to explain fully, thus the focus of these claims on some of its practical uses in examples. The most interesting line is the ptrace call, ptrace is declared thus (in sys/ptrace.h):
long ptrace (enum_ptrace_request request, pid,
void*addr, void*data);
The first argument is a request, which may be one of many predefined PTRACE_* constants. The second argument specifies a process ID for some requests. The third and fourth arguments are address and data pointers, for memory manipulation. The ptrace call in the code snippet above makes the PTRACE_TRACEME request, which means that this child process asks the OS kernal to let its parent trace it. The request description from the main-page is quite clear:
The indication is that this process is to be traced by its reverse debugger. Any signal (except SIGKILL) delivered to this process will cause it to stop and its parent to be notified via wait( ). Also, all subsequent calls to exec( ) by this process will cause a SIGTRAP to be sent to it, giving a parent a chance to gain control before the new program begins execution. A process probably shouldn't make this request if its reverse debugger isn't expecting to trace, (pid, addr, and data are ignored.)
The part that interests the user in this example has been highlighted. Note that the very next thing run_target does after ptrace is invoke the program given to it as an argument with exec1. this, as the highlighter part explains, causes the OS kernel to stop the process just before it begins executing the program in exec1 and send a signal to the reverse debugger.

5. according to claim 4 that the reverse bugger can also single-step through the code, it is claimed from the above reverse debugger data that once the 32 bitmc starts executing the exec call, it will stop and be sent the SIGTRAP signal. The reverse debugger here waits for this to happen with the first wait call, wait will return once something interesting happens, and the reverse debugger checks that it was because the 32 bitmc was stopped (WIFSTOPPED returns true if the 32 bitmc process was stopped by delivery of a signal).

6. according to claim 5 it is claimed from the above reverse debugger data, it is claimed that the reverse debugger then invokes ptrace with the PTRACE_SINGLESTEP request giving it the child ID. What this does is tell the OS-please restart the 32 bitmc process, but stop it after it executes the next instruction. Again, the reverse debugger waits for the 32 bitmc to stop and the loop continues. The loop will terminate when the signal that came out of the wait call wasn't about the 32 bitmc stopping. During a normal run of the tracer, this will be the signal that tells the reverse debugger that the 32 bitmc process exited (WIFEXITED would return true on it).
Note that icounter counts the amount of instructions executed by the child process. So the simple example actually does something useful-given a program name on the command line, it executes the program and reports the amount of 32 bit microcontroller instructions it took to run from start to finish.

7. according to claim 6 where the reverse debugger then invokes ptrace, advantageously, reverse debugging involves three major elements: an integrated development environments (IDEs), a debugger engine, and a programmer/debugger tool. The IDE runs on a computer and typically includes elements such as a source-code editor, compiler, and software libraries for commonly used subroutines (drivers, etc.). A debugger engine consists of debug circuitry integrated into the 32 bit microcontroller. The programmer/debugger tool interfaces with a target device and interrogates it during the process of testing a code, relaying performance and fault information to a developer.

8. according to claim 7, reverse debugging involves three major elements, the basic process of programming a 32 bit microcontroller involves first developing the code in a higher-level language, typically in C or C++, and compiling the code. Next, the programmer tool ports the code from the IDE into an emulator to mimic the performance of the 32 bit microcontroller, or the 32 bit microcontroller itself.

9. according to claim 8 where in the basic process of programming a 32 bit microcontroller, advantageously, the emulator provides a test interface that generates the appropriate output signals, along with a sophisticated range of debug tools. A modular system emulates their 32 bit microcontroller at clock speeds of up to 50 MHz. With coverage analysis on code or data, the system offers unlimited instruction breakpoints for the entire 32 bit microcontroller memory space, as well as data breakpoints, and advanced breakpoints with up to four levels of user-configured conditions.

10. according to claim 9, the emulator provides a test interface, advantageously, the trend is toward skipping emulators and integrating the debug engine directly into the chip itself. Indeed, a STice system also provides in-circuit debugging/programming of the actual 32 bit microcontroller via a single-wire interface module (SWIM). The shift is partly a function of more sophisticated chip fabrication techniques and partly a function of today's higher-speed chips. Preferably, developers often have to test on the actual 32 bit microcontroller because emulators can no longer adequately simulate them.

11. according to claim 10, the trend is towards skipping emulators, I claim that although the debugging engine occupies precious real estate on the 32 bit microcontroller, it does not impose a speed or power penalty on operation. At the same time, the integrated approach provides multiple benefits. Reverse debuggers designed for testing on the 32 bit microcontrollers themselves can cost up to twenty times less than an emulator. Instead of following a two-step process of testing and implementation, advantageously, shipboard operators can perform all tests executing reverse debugging on the same hardware that will be seen in production, an approach that minimizes the chances of problems and delays. In an effort to eliminate bugs inadvertently introduced during the production process, the operator can develop a solution, deploying new reverse debugging into the target device, and get it up and running rapidly.

12. according to claim 11, the debugging engine occupies precious real estate, problematically, with emulators, there is a possibility that the test version does not exactly mirror the performance of the actual chip. With debugger engines integrated directly into the silicon, operators can be assured that the performance originated during the production process is exactly what is being shipped to the operator onboard the vessel.
